(19) United States
(12) Patent Application Publication
(10) Pub. No.: US 2024/0003021 A1
(43) Pub. Date: Jan. 4, 2024

(54) MEMBRANELESS ELECTROLYZERS FOR THE PRODUCTION OF ALKALINE AND ACIDIC EFFLUENT STREAMS

(71) Applicants: Daniel Esposito, Mount Vernon, NY (US); Quinten van Hinsberg, Antwerp (BE)

(72) Inventors: Daniel Esposito, Mount Vernon, NY (US); Quinten van Hinsberg, Antwerp (BE)

(73) Assignee: The Trustees of Columbia University in the City of New York, New York, NY (US)

(21) Appl. No.: 18/036,971

(22) PCT Filed: Nov. 16, 2021
(86) PCT No.: PCT/US2021/059470

§ 371 Date: May 15, 2023

Related U.S. Application Data
(60) Provisional application No. 63/279,338, filed on Nov. 15, 2021.
(60) Provisional application No. 63/114,234, filed on Nov. 16, 2020.

(51) Int. Cl. C25B 9/70; C25B 11/031; C25B 1/04; C25B 1/26; C25B 15/08

(52) U.S. Cl. CPC C25B 9/70; C25B 11/031; C25B 15/087; C25B 1/26; C25B 1/04

(57) ABSTRACT

The system includes electrolyzers to generate acidic and alkaline effluent streams from saltwater. The electrolyzer include stacked pairs of porous anodes and cathodes that define feed channels into which reactants, e.g., hydrogen and brine, can be pumped to undergo an oxidation-reduction reaction. The porous cathode carries out the HER to generate H₂, which floats upwards to the porous anode, where it is oxidized through the HOR. The reaction can thus progress in a self-maintaining manner. The HER creates an alkaline product stream with increased basicity, and the HOR an acidic product stream with increased acidity, compared to the inlet stream. Streams are pumped through the porous electrodes and the electrolyzer to sweep effluent through separate channels before they can combine. The alkaline product stream can have an alkalinity sufficient to drive metal ion precipitation in raw saltwater prior to feeding to the electrolyzer to reduce fouling/degradation of electrolyzer electrodes.

### CROSS REFERENCE TO RELATED APPLICATION(S)

This application claims the benefit of U.S. Provisional Application Nos. 63/114,234, filed Nov. 16, 2020, and 63/279,338, filed Nov. 15, 2021, which are incorporated by reference as if disclosed herein in their entireties.

### BACKGROUND

Electrolysis is a very important industrial process used to produce a variety of vital chemical building blocks. Processes such as the chlor-alkali process, electro-synthesis of anthraquinone, and electro-fluoridation all play essential roles in the production of chemicals used in our everyday lives. Electrolysis can be an energy efficient process with a significantly lower carbon footprint compared to traditional thermal catalysis processes if the input electricity is derived from a renewable resource such as wind or solar. As of 2006, chemical production by electrochemical processes made up more than 6% of the total electrical generating capacity of the United States, with the most energy intensive process being performed by the chlor-alkali industry. These processes are used to produce hydrogen gas, caustic soda (sodium hydroxide), and chlorine gas. For the chlor-alkali processes, and most electrolysis processes, the economics are dominated by the cost of electricity, which accounts for a significant fraction of the total manufacturing cost. However, the decreasing costs of electricity from renewable resources and the continued adoption of time-of-use pricing schemes are likely to change the economics of electrochemical processes, shifting importance towards decreasing the capital cost of the electrolyzer system itself.

In the chlor-alkali (CA) industry there is a concept frequently employed during the production of chlorine (Cl₂) and sodium hydroxide (NaOH) that involves replacing the hydrogen evolution reaction (HER) with oxygen (O₂) reduction at the cathode, which still results in NaOH as a co-product but requires lower voltage compared to conventional CA electrolyzers. This is called a “oxygen depolarized cathode” (ODP). In a similar manner, a “hydrogen depolarized anode” (HDA) based on oxidation of hydrogen (H₂) at the anode rather than the oxygen evolution reaction (OER) can be used to reduce the cell voltage of a process used to produce acid at the anode. Implementing a “hydrogen depolarized anode” (HDA) in a conventional membrane reactor based on cation exchange membranes is challenging because protons generated on the acid side will out-compete Na⁺ for transport across the membrane. Similarly, it would be difficult to have selective transport for Cl⁻ over OH⁻ in an anion exchange membrane (AEM) based electrolysis cell.

Going back to at least 1865, it has been known that Mg²⁺ ions can be harvested from seawater by elevating the pH of seawater such that Mg²⁺ reacts with hydroxyls (OH⁻) to form insoluble Mg(OH)₂. To this date, Mg(OH)₂ is still commercially obtained by this means through the addition of quick lime (Calcium oxide, CaO) to seawater. However, the production of quick lime, like Portland cement, involves a large carbon footprint because is obtained from CaCO₃ in the form of limestone.

The process chemistry of the chlor-alkali process is relatively simple but the operational and reactor design issues are vastly complex. The most energy efficient electrolyzer in the chlor-alkali industry is the membrane electrolyzer. The membrane electrolyzer functions by separating anolyte and catholyte streams by means of an ion selective membrane and that only allows cationic species, e.g., Na⁺, K⁺, H⁺ and small amounts of water to pass through it. Diaphragm electrolyzers and mercury electrolytic cells are also used to produce bases, although these technologies are being phased out in favor of membrane reactors. This is due to health and environmental concerns relating to the use of asbestos and mercury, respectively. Key challenges with membrane electrolyzers include the high cost of the ion-selective membranes and their susceptibility to fouling, which require that very high purity water or brine solution be used as the input. Various approaches have been pursued in order to improve the yield, energy efficiency, economics, and environmental impacts of the membrane process.

There's potentially a big opportunity to implement an HDA in a membrane-free design.

### SUMMARY

Some embodiments of the present disclosure include a system for producing acidic and alkaline products from aqueous salt solutions. In some embodiments, the system includes an electrolyzer including at least one reactor chamber including a feed channel, an anode effluent channel, and a cathode effluent channel. In some embodiments, the electrolyzer includes one or more porous anodes positioned between the feed channel and the anode effluent channel. In some embodiments, the electrolyzer includes one or more porous cathodes positioned between the feed channel and a cathode effluent channel. In some embodiments, the electrolyzer includes one or more aqueous salt solution inlet streams in fluid communication with the feed channel. In some embodiments, the electrolyzer includes one or more gas inlet streams in fluid communication with the at least one reactor chamber. In some embodiments, the electrolyzer includes one or more acidic product streams in fluid communication with the anode effluent channel. In some embodiments, the electrolyzer includes one or more alkaline product streams in fluid communication with the cathode effluent channel. In some embodiments, the electrolyzer includes one or more pH-neutral product streams in fluid communication with the liquid electrolyte gap interposed between the anode and cathode.

In some embodiments, a first porous anode and a first porous cathode are positioned in a stacked configuration with the feed channel disposed therebetween. In some embodiments, the aqueous salt solution inlet stream includes brine, brackish water, seawater, reject brine, or combinations thereof. In some embodiments, the gas inlet stream is dissolved gas in the aqueous salt solution inlet stream. In some embodiments, the gas inlet stream includes gaseous hydrogen, oxygen, chlorine, or combinations thereof. In some embodiments, a first gaseous stream is evolved at the first porous cathode. In some embodiments, at least a portion of the first gaseous stream is recycled to the first anode. In some embodiments, a first gaseous stream is evolved at the first porous anode, and at least a portion of the first gaseous stream is recycled to the reactor chamber.

In some embodiments, the electrolyzer includes a first reactor chamber including a first feed channel, a first anode effluent channel, and a first cathode effluent channel and at least a second reactor chamber including a second feed channel, a second anode effluent channel, and a second cathode effluent channel. In some embodiments, a first acidic product stream from the first anode effluent channel is in fluid communication with the second feed channel, a first alkaline product stream is in fluid communication with the first cathode effluent channel, a second acidic product stream is in fluid communication with the second anode effluent channel, and a second alkaline product stream from the second cathode effluent channel is in fluid communication with the first feed channel. In some embodiments, the one or more acidic product streams are in communication with a second electrolyzer, a mixing tank including alkaline minerals, a neutralization unit including at least a portion of an alkaline product stream, or combinations thereof. In some embodiments, the one or more alkaline product streams are in communication with a carbon dioxide feed stream, a water electrolyzer, a feedstream of aqueous salt solution, a neutralization unit include at least a portion of an acidic product stream, or combinations thereof.

Some embodiments of the present disclosure are directed to a system for producing acidic and alkaline products from aqueous salt solutions, comprising an electrolyzer. In some embodiments, the electrolyzer includes a reactor chamber including a feed channel, an anode effluent channel, and a cathode effluent channel. In some embodiments, the electrolyzer includes one or more porous anodes positioned between the feed channel and the anode effluent channel. In some embodiments, the electrolyzer includes one or more porous cathodes positioned between the feed channel and a cathode effluent channel. In some embodiments, a first porous anode and a first porous cathode are positioned in a stacked configuration with the feed channel disposed therebetween.

In some embodiments, the system includes one or more gas inlet streams in fluid communication with the at least one reactor chamber. In some embodiments, the system includes one or more acidic product streams in fluid communication with the anode effluent channel. In some embodiments, the system includes one or more alkaline product streams in fluid communication with the cathode effluent channel. In some embodiments, the system includes a feedstream including aqueous salt solution. In some embodiments, the system includes a precipitation tank in fluid communication with the feedstream and at least a portion of the one or more alkaline product streams, the precipitation tank producing an aqueous salt solution inlet stream in fluid communication with the feed channel and a metal-including product outlet stream. In some embodiments, the system includes one or more neutralization tanks in fluid communication with at least a portion of the one or more alkaline product streams and at least a portion of the one or more acidic product streams. In some embodiments, the system includes a power supply in electrical communication with the one or more porous anodes and the one or more porous cathodes.

In some embodiments, the feedstream includes brine, brackish water, seawater, reject brine, or combinations thereof. In some embodiments, the system includes a carbon dioxide feedstream in communication with the precipitation tank. In some embodiments, the system includes a second electrolyzer in fluid communication with at least a portion of the one or more alkaline product streams, the second electrolyzer producing a hydrogen gas product, an oxygen product, or combinations thereof. In some embodiments, the system includes a mixing tank in fluid communication with at least a portion of the one or more acidic product streams and the metal-including product outlet stream, an alkaline mineral source, or combinations thereof.

Some embodiments of the present disclosure include a method for producing acidic and alkaline products from aqueous salt solutions including providing an electrolyzer. In some embodiments, the electrolyzer includes a first reactor chamber including a first feed channel, a first anode effluent channel, a first cathode effluent channel, a first porous anode positioned between the first feed channel and the first anode effluent channel, and a first porous cathode positioned between the first feed channel and the first cathode effluent channel. In some embodiments, a first porous anode and a first porous cathode are positioned in a stacked configuration with the first feed channel disposed therebetween. In some embodiments, the electrolyzer includes a second reactor chamber including a second feed channel, a second anode effluent channel, a second cathode effluent channel, a second porous anode positioned between the second feed channel and the second anode effluent channel, and a second porous cathode positioned between the second feed channel and the second cathode effluent channel. In some embodiments, the second porous anode and the second porous cathode are positioned in a stacked configuration with the second feed channel disposed therebetween. In some embodiments, the electrolyzer includes one or more aqueous salt solution inlet streams in fluid communication with the first feed channel, the second feed channel, or combinations thereof. In some embodiments, the electrolyzer includes one or more gas inlet streams in fluid communication with the first reactor chamber, the second reactor chamber, or combinations thereof. In some embodiments, an acidic stream from the first anode effluent channel is fed to the second feed channel and an alkaline stream from the second cathode effluent channel is fed to the first feed channel.

In some embodiments, the method includes providing a feedstream including aqueous salt solution. In some embodiments, the method includes feeding an aqueous salt inlet stream to the first feed channel or the second feed channel. In some embodiments, the method includes applying a voltage to the porous anodes and the porous cathodes. In some embodiments, the method includes performing an oxidation-reduction reaction at the porous anodes and the porous cathodes to evolve one or more acidic product streams and one or more alkaline product streams from the electrolyzer. In some embodiments, the method includes contacting at least a portion of the alkaline product stream with the feedstream to precipitate a metal-including product from the feedstream and generate additional aqueous salt inlet stream. In some embodiments, the feedstream includes brine, brackish water, seawater, reject brine, or combinations thereof.

In some embodiments, the method includes contacting at least a portion of the alkaline product stream with a carbon dioxide feedstream, isolating a metal carbonate product, and releasing carbon dioxide from the metal carbonate product to produce a concentrated carbon dioxide product. In some embodiments, the method includes contacting at least a portion of the acidic product stream with the metal-including product, an alkaline mineral source, or combinations thereof. In some embodiments, the method includes contacting at least a portion of the acidic product stream with at least a portion of the alkaline product stream. In some embodiments, the method includes contacting at least a portion of the acidic product stream with at least a portion of the aqueous salt inlet stream to form a neutralized inlet stream and feeding the neutralized inlet stream to a second electrolyzer in fluid communication with a source of oxygen to generate a chlorine gas product stream.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIGS. 1A-1C are schematic representations of systems for producing acidic and alkaline products from aqueous salt solutions according to some embodiments of the present disclosure;

FIG. 2 is a schematic representation of a system for producing acidic and alkaline products from aqueous salt solutions according to some embodiments of the present disclosure;

FIG. 3A is a graph portraying pH curves for alkaline product streams produced by electrolyzers according to some embodiments of the present disclosure;

FIG. 3B is a graph portraying pH curves for acidic product streams produced by electrolyzers according to some embodiments of the present disclosure;

FIG. 3C is a graph portraying current-voltage (IV) curves for single-cell electrolyzers according to some embodiments of the present disclosure using synthetic seawater (0.6 M NaCl);

FIG. 3D is a graph portraying current-voltage (IV) curves for electrolyzers according to some embodiments of the present disclosure using synthetic seawater (0.6 M NaCl);

FIG. 3E is a graph portraying current-voltage (IV) curves for electrolyzers according to some embodiments of the present disclosure using Hz-purged synthetic seawater (0.6 M NaCl);

FIG. 3F is a graph portraying current-voltage (IV) curves for electrolyzers according to some embodiments of the present disclosure using Hz-purged Mg-free seawater;

FIGS. 4A-4B portray images of electrolyzers according to some embodiments of the present disclosure;

FIG. 5A is a graph portraying current-voltage curves are shown for electrolyzers according to some embodiments of the present disclosure using acidic feedstream (0.5 M H₂SO₄);

FIG. 5B is a graph portraying current-voltage curves for electrolyzers according to some embodiments of the present disclosure using aqueous 0.6M NaCl as the inlet stream;

FIG. 5C is a graph portraying current-voltage curves for electrolyzers according to some embodiments of the present disclosure using aqueous 0.6M NaCl and H₂(aq) as the inlet stream at a feedstream flow rate 20 mL/min; and

FIG. 6 is a chart of a method for producing acidic and alkaline products from aqueous salt solutions according to some embodiments of the present disclosure.

### DESCRIPTION

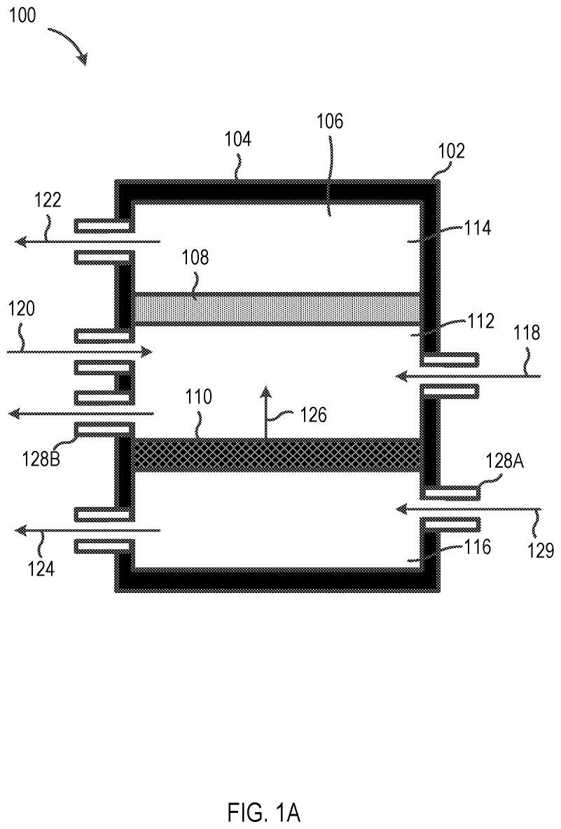

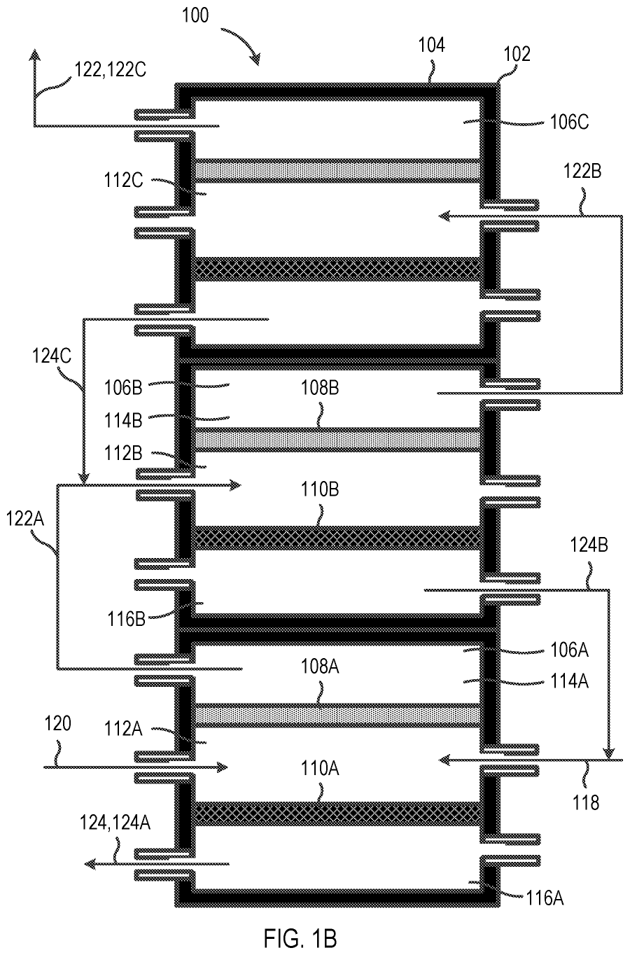

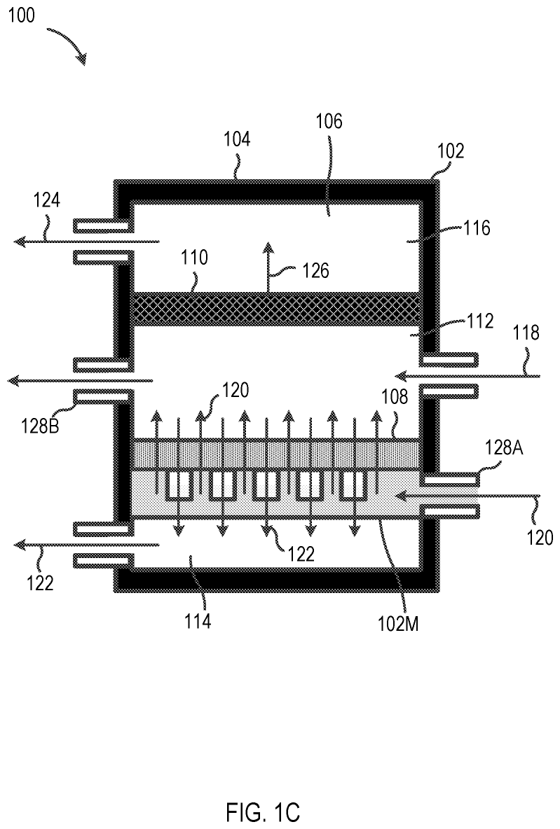

Referring now to FIGS. 1A-1C, some aspects of the present disclosure are directed to a system 100 for producing products from solutions including one or more aqueous salts. In some embodiments, system 100 produces one or more acidic products. In some embodiments, system 100 produces one or more alkaline products. In some embodiments, portions of the acidic and/or the basic products are combined with each other or other acidic or basic components to produce one or more neutral products, as will be discussed in greater detail below.

In some embodiments, system 100 includes one or more electrolyzers 102. In some embodiments, system 100 includes a plurality of electrolyzers 102, e.g., operating in series, operating in parallel, or combinations thereof. In some embodiments, electrolyzer 102 includes a cell body 104. In some embodiments, cell body 104 is composed of any suitable material or combination of materials to facilitate the transportation of reactants, reaction of those reactants, and removal of reaction products, as will be discussed in greater detail below. In some embodiments, cell body 104 is composed of one or more polymers. Cell body 104 includes a plurality of channels, chambers, etc., for allowing flow of liquids and gases through electrolyzer 102. In some embodiments, electrolyzer 102 is membraneless or membrane-free, i.e., does not include a membrane.

Still referring to FIG. 1A, in some embodiments, electrolyzer 102 includes at least one reactor chamber 106. In some embodiments, electrolyzer 102 includes one or more anodes 108 and one or more cathodes 110. In some embodiments, electrolyzer 102 includes a plurality of pairs of anode 108 and cathode 110. In some embodiments, at least one pair of anode 108 and cathode 110 are included in each reactor chamber 106. In some embodiments, anode 108 and cathode 110 are porous. In some embodiments, the porous anodes 108 and cathodes 110 are mesh shaped as a ring, wire, disk, band, or plate. In some embodiments, anodes 108 and cathodes 110 can be made of any suitable material for operating within electrolyzer 102 with the given reactants, e.g., carbon foam electrodes. In some embodiments, anodes 108 and cathodes 110 are in electrical communication with one or more power sources to provide voltage across the anode/cathode pairs. In some embodiments, the voltage is constant, pulsed, or combinations thereof.

In some embodiments, electrolyzer 102 includes one or more feed channels 112. In some embodiments, the dimensions of feed channel 112 are defined by anode 108, cathode 110, and walls of cell body 104. In some embodiments, electrolyzer 102 includes one or more anode effluent channels 114. In some embodiments, an anode 108 is positioned between feed channel 112 and anode effluent channel 114. In some embodiments, electrolyzer 102 includes one or more cathode effluent channels 116. In some embodiments, a cathode 110 is positioned between feed channel 112 and cathode effluent channel 116.

As discussed above, in some embodiments, pairs of anode 108 and cathode 110 are each positioned within a reactor chamber 106. In some embodiments, pairs of anode 108 and cathode 110 are each positioned completely within a reactor chamber 106. In some embodiments, pairs of anode 108 and cathode 110 are positioned at least substantially parallel to each other. In some embodiments, pairs of anode 108 and cathode 110 are positioned in a stacked configuration, i.e., one of the anode or cathode is positioned above the other along a non-horizontal axis NH. In some embodiments, anode 108 is positioned above cathode 110 within reactor chamber 106. In some embodiments, cathode 110 is positioned above anode 108 in reactor chamber 106.

Again referring to FIG. 1A, in some embodiments, electrolyzer 102 includes one or more aqueous salt solution inlet streams 118. Aqueous salt solution inlet stream 118 is in fluid communication with reactor chamber 106 to deliver aqueous salt solution to electrolyzer 102. In some embodiments, aqueous salt solution inlet stream 118 has a substantially neutral pH. In some embodiments, aqueous salt solution inlet stream 118 includes a pH neutral product stream produced elsewhere in system 100, as will be discussed in greater detail below. In some embodiments, aqueous salt solution inlet stream 118 has a pH above about 9. In some embodiments, aqueous salt solution inlet stream 118 has a pH of about 11. In some embodiments, the aqueous salt solution includes brine, brackish water, seawater, reject brine, or combinations thereof. In some embodiments, aqueous salt solution inlet stream 118 is in fluid communication with feed channel 112. In some embodiments, electrolyzer 102 includes one or more gas inlet streams 120. Gas inlet stream 120 is in fluid communication with reactor chamber 106 to deliver a gas component to electrolyzer 102. In some embodiments, gas inlet stream 120 is dissolved gas in aqueous salt solution inlet stream 118. In some embodiments, gas inlet stream 120 is gaseous and bubbled directly into reactor chamber 106. In some embodiments, gas inlet stream 120 is in fluid communication with feed channel 112, anode effluent channel 114, or combinations thereof. In some embodiments, gas inlet stream includes hydrogen, oxygen, chlorine, or combinations thereof.

In some embodiments, electrolyzer 102 includes one or more acidic product streams 122. In some embodiments, acidic product stream is in fluid communication with anode effluent channel 114. In some embodiments, electrolyzer 102 includes one or more alkaline product streams 124. In some embodiments, alkaline product stream 124 is in fluid communication with cathode effluent channel 116.

In some embodiments, a gaseous stream 126 is evolved at cathode 110. In some embodiments, at least a portion of gaseous stream 126 evolved at cathode 110 is fed to anode 108. In some embodiments, at least a portion of gaseous stream 126 evolved at cathode 110 is removed from reactor chamber 106 and recycled, e.g., to anode 108. In some embodiments, gaseous stream 126 is evolved at anode 108. In some embodiments, at least a portion of gaseous stream 126 evolved at anode 108 is fed to cathode 110. In some embodiments, at least a portion of gaseous stream 126 evolved at anode 108 is removed from reactor chamber 106 and recycled, e.g., to cathode 110.

Once fed into cell body 104 and reactor chamber 106, e.g., at feed channel 112, aqueous salt solution inlet stream 118 contacts porous cathode 110 and porous anode 108. A voltage is applied to cathode 110 and anode 108, facilitating an oxidation-reduction reaction at the porous anode and the porous cathode to evolve acidic product streams 122 and alkaline product streams 124, respectively. Streams in electrolyzer 102 are pumped through the two porous electrodes and the electrolyzer to sweep acidic product streams 122 and alkaline product streams 124 through separate effluent channels (anode effluent channel 114 and cathode effluent channel 116, respectively) before they can combine. In some exemplary embodiments, porous cathode 110 carries out a hydrogen evolution reaction (HER) to generate dissolved and/or gaseous H₂ bubbles. The H₂ is then fed back to porous anode 108, e.g., removed from electrolyzer 102 and fed back to the anode, where it is subsequently oxidized through a hydrogen oxidation reaction (HOR). These two redox reactions generate acidic product stream 122 exiting electrolyzer 102, e.g., at the bottom via anode effluent channel 114, and alkaline product stream 124 exiting the electrolyzer, e.g., at the top via cathode effluent channel 116. Fluid being pumped through electrolyzer 102 sweeps the salty acid and salty base products into separate channels before they can combine, leading to the overall reaction (Equations 1-3) which is simply the water dissociation reaction:

Oxidation:H₂→2H⁺+2e⁻E°=+0.059·(pHₐ)Vvs.NHE (1.)

Reduction:2H₂O+2e⁻→H₂+2OH⁻E°=−0.059·(pH_{c})Vvs.NHE (2.)

Overall Reaction:H₂O→H⁺|_{anode}+OH⁻|_{cathode}ΔE°=0.059·ΔpH (3.)

where ΔE° is the minimum voltage to drive the overall reaction at the desired pH difference of ΔpH=pHₐ−pH_{c}. Without wishing to be bound by theory, the reaction scheme given by Equations (1)-(3) is highly favorable for generating acid and base in seawater for three reasons: (i.) the hydrogen oxidation reaction (HOR) occurring at the anode can easily outcompete the undesirable chlorine evolution reaction (CER), (ii.) the cell voltage is substantially lower than that required for water electrolysis, and (iii.) there is no safety concern about mixing O₂ and H₂ because O₂ is not involved in either half reaction. Still not wishing to be bound by theory, the minimum flow rate of seawater through the system is that determined by the amount of H₂O required for H₂ production and to avoid increasing the salinity of the water >5 or 10% to comply with regulations. This minimum flow rate also minimizes the energy use contribution from electrolyzer 102.

In an alternative exemplary embodiment, aqueous salt solution inlet stream 118 is fed into the gap between porous anode 108 and porous cathode 110, e.g., feed channel 112, such that the solution passes through the electrodes while a voltage is applied between them to facilitate electrochemical oxidation and reduction reactions, using H₂ as the gaseous reductant species and water as the oxidant species. As discussed above, in some embodiments, the inlet brine solution includes a dissolved and/or gaseous component, e.g., hydrogen, that is subsequently oxidized at porous anode 108. Porous cathode 110 carries out the HER to generate dissolved and/or gaseous H₂ bubbles (gaseous stream 126), which in this embodiment, a portion of which floats upwards to anode 108, where at least a portion of it is subsequently oxidized through the HOR. Without wishing to be bound by theory, because H₂ is being generated at the bottom cathode 110 while it is simultaneously consumed at the top porous anode 108, the reaction can progress in a self-maintaining or autocatalytic manner. Further, during operation, the reduction reaction creates an alkaline product stream 124 that is more alkaline than the inlet stream, while the oxidation reaction creates an acidic product stream 122 that is more acidic than the inlet stream.

Referring now specifically to FIG. 1B, in some embodiments, electrolyzer 102 includes a plurality of reactor chambers 106 within the same cell body 104. In some embodiments, a plurality of reactor chambers 106 can be stacked such that the feed and effluent streams are connected in a manner that generates increasingly more concentrated acidic and alkaline streams exiting the cells located at the top and/or bottom of the stack. In some embodiments, fluid flow between various effluent streams can be facilitated by pumps (not shown), gravity-induced flow, or combinations thereof. In exemplary embodiment of FIG. 1B, three reactor chambers 106 are shown, however the present disclosure is not limited in this regard, as two or four or more reactor chambers can also be included in cell body 104 and connected in any suitable manner consistent with the present disclosure to provide an acidic product stream 122 and an alkaline product stream 124 from electrolyzer 102.

Still referring to FIG. 1B, in some embodiments, electrolyzer 102 includes a first reactor chamber 106A including a first porous anode 108A, a first porous cathode 110A, a first feed channel 112A, a first anode effluent channel 114A, and a first cathode effluent channel 116A. In some embodiments, electrolyzer 102 includes a second reactor chamber 106B including a second porous anode 108B, a second porous cathode 110B, a second feed channel 112B, a second anode effluent channel 114B, and a second cathode effluent channel 116B. Aqueous salt solution inlet stream 118 and gas inlet stream 120 are provided to electrolyzer 102, e.g., at first feed channel 112A, second feed channel 112B, combinations thereof, etc.

In some embodiments, one or more first acidic product streams 122A are generated from first anode effluent channel 114A. In some embodiments, at least a portion of first acidic product stream 122A is provided to second reactor chamber 106B, e.g., second feed channel 112B. In some embodiments, one or more first alkaline product streams 124A are generated from first cathode effluent channel 116A. In some embodiments, at least a portion of first alkaline product stream 124A is removed from electrolyzer 102. In some embodiments, at least a portion of first alkaline product stream 124A is provided to another reactor chamber in electrolyzer 102.

In some embodiments, one or more second alkaline product streams 124B are generated from second cathode effluent channel 116B. In some embodiments, at least a portion of second alkaline product stream 124B is provided to first reactor chamber 106A, e.g., first feed channel 112A. In some embodiments, one or more second acidic product streams 122B are generated from second anode effluent channel 114B. In some embodiments, at least a portion of second acidic product stream 122B is removed from electrolyzer 102. In some embodiments, at least a portion of second acidic product stream 122B is provided to another reactor chamber in electrolyzer 102, e.g., a third reactor chamber 106C at a third feed channel 112C, where it can further generate third acidic product stream 122C (or acidic product stream 122) and third alkaline product stream 124C for feeding back to second reactor chamber 106B. Thus, acidic product streams are delivered to reactor chambers to generate even more acidic product streams, while alkaline product streams are delivered to other reactor chambers to generate even more basic product streams. When the acidity/basicity of the product streams reaches the desired level, the product streams can be removed. In some embodiments, at least a portion of acidic product stream 122 is in communication with a second electrolyzer, a mixing tank including alkaline minerals, a neutralization unit including at least a portion of an alkaline product stream, or combinations thereof. In some embodiments, at least a portion of alkaline product stream 124 is in communication with a carbon dioxide feed stream, a water electrolyzer, a feedstream of aqueous salt solution, a neutralization unit including at least a portion of an acidic product stream, or combinations thereof.

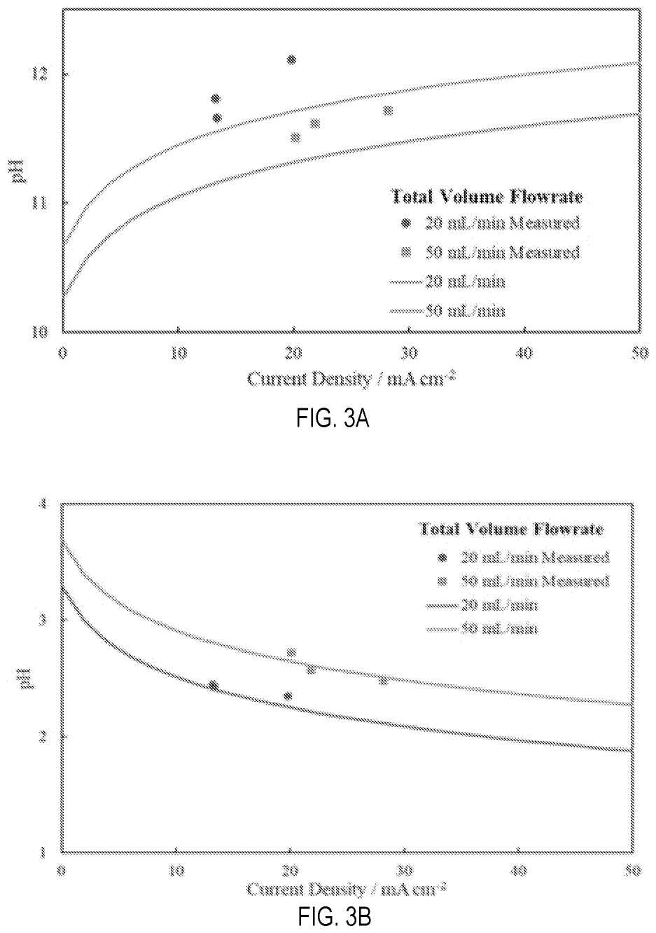

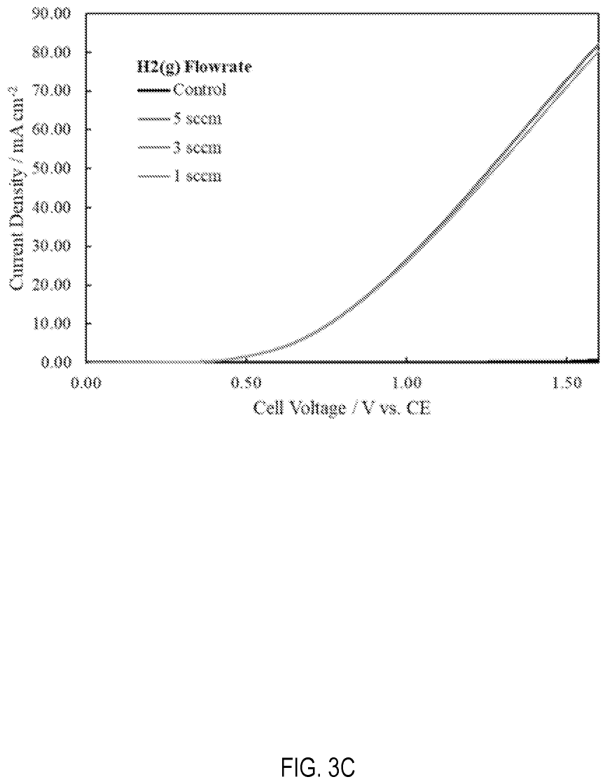

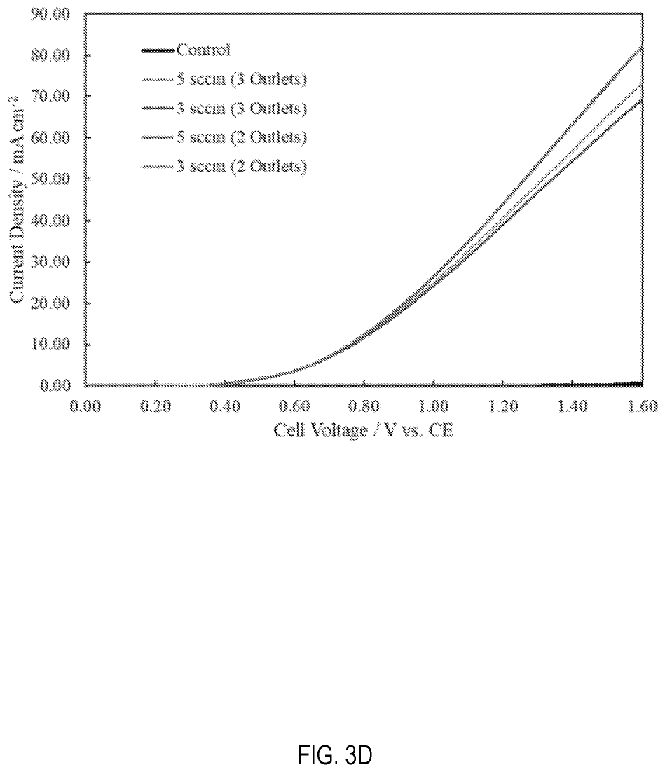

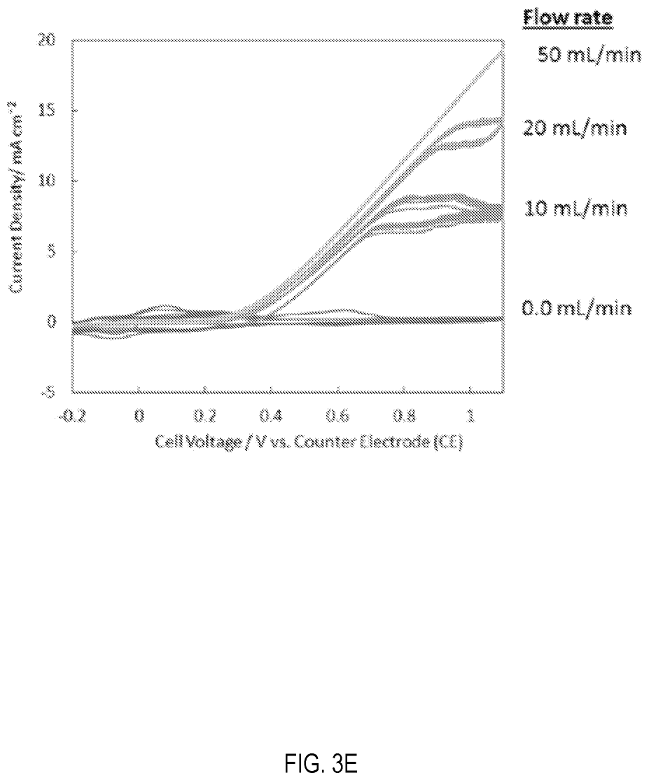

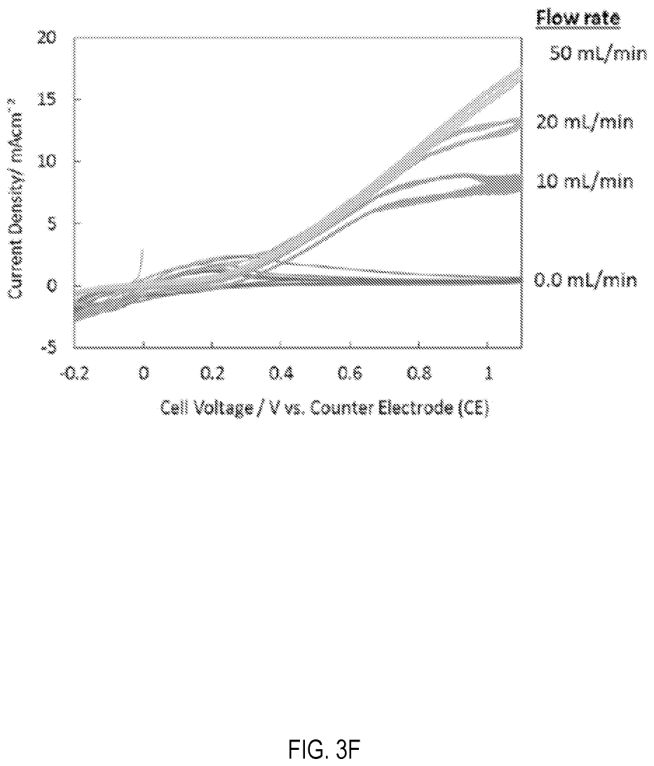

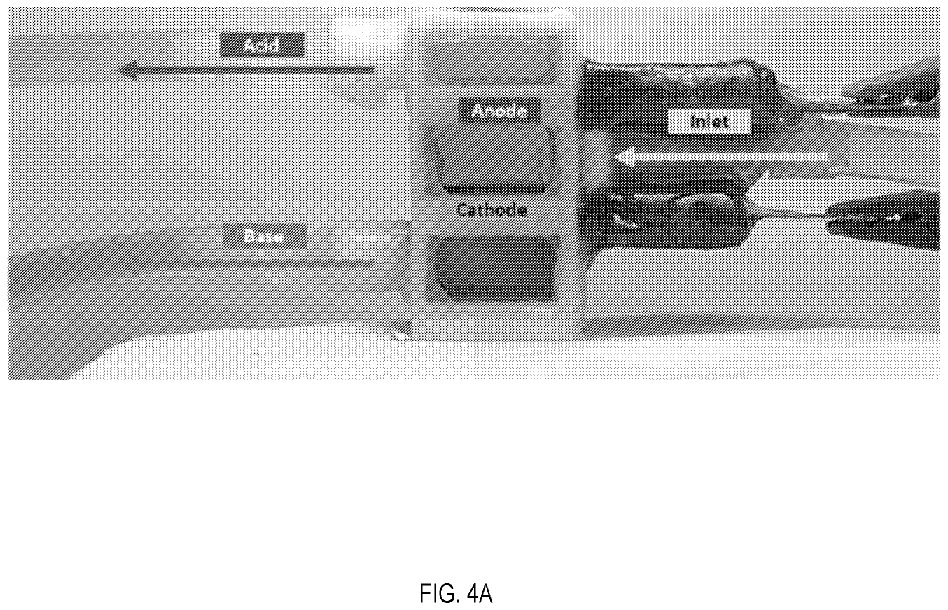

Referring again to FIG. 1A, in some embodiments, electrolyzer 102 includes additional inlet ports 128A for feeding additional reactant streams 129, such as gaseous bubbles, a recycled stream, solutions including dissolved gasses, etc., into feed channel 112, anode effluent channel 114, cathode effluent channel 116, or combinations thereof. In some embodiments, electrolyzer 102 includes additional inlet ports 128B, e.g., for removing unreacted reactant from feed channel 112. By way of example, electrolyzer 102 can also be applied to other reversible electrochemical reactions involving a gaseous redox species that can serve as both reductant at porous anode 108 and oxidant at porous cathode 110. Example chemistries include, but are not limited to, those based on the reversible oxygen (O₂) and chlorine (Cl₂) reactions. Other exemplary embodiments based on one gas phase reactant and one liquid phase reactant are also contemplated. In an exemplary embodiment, O₂ is fed to electrolyzer 102 such that the oxygen evolution reaction (OER) occurs at a bottom porous anode while the oxygen reduction reaction (ORR) occurs at a top porous cathode. In some embodiments, these two redox reactions generate acidic effluent exiting the bottom anode chamber and alkaline effluent existing the top cathode chamber. In some embodiments, ORR is coupled with water oxidation to produce O₂, an acidic product, and a basic product, or a chlorine evolution reaction to produce Cl₂ and base product, etc. Referring now to FIGS. 3A-3F, electrolyzers 102 were able to generate increasingly acidic and alkaline product streams with increased current densities (see FIGS. 3A-3B). These elevated current densities were achievable particularly with the use of gaseous hydrogen as the gaseous inlet to the electrolyzer (see FIGS. 3C-3D), although a similar trend was achievable with dissolved hydrogen as well (see FIGS. 3E-3F).

Referring now to FIG. 1C, in some embodiments, electrolyzer 102 includes a manifold 102M. Manifold 102M is positioned and configured to deliver gas inlet streams 120 directly to one of anode 108 and/or cathode 110. In the exemplary embodiment shown in FIG. 1C, manifold 102M delivers gas inlet stream 120 to anode 108, which is positioned below cathode 110 within reactor chamber 106. In some embodiments, manifold 102M includes one or more gas delivery channels that allow gas inlet stream 120 to escape at a desired location in reactor chamber 106, e.g., adjacent anode 108. In some embodiments, gas inlet stream 120 is at least partially made up of a portion of gaseous stream 126 from electrolyzer 102 that is recycled, e.g., back to inlet port 128A. As discussed above, the oxidation reaction at anode 108 creates acidic product stream 122 that is more acidic than the inlet stream, which is subsequently removed via anode effluent channel 114.

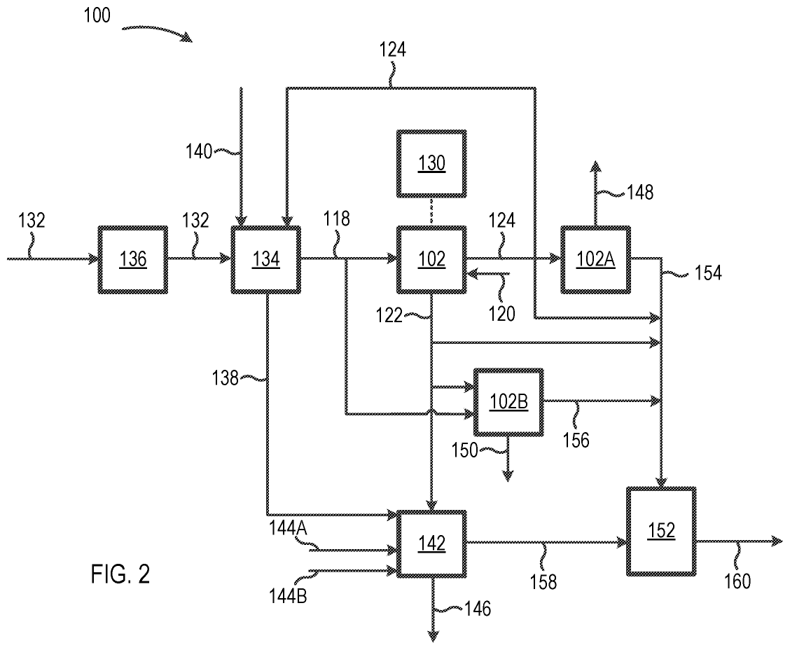

Referring now to FIG. 2, in some embodiments, electrolyzer 102 is incorporated into a multi-component system 100 for producing acidic and alkaline products from aqueous salt solutions. As discussed above, in some embodiments, electrolyzer 102 includes a reactor chamber including a feed channel, an anode effluent channel, a cathode effluent channel, one or more porous anodes positioned between the feed channel and the anode effluent channel, one or more porous cathodes positioned between the feed channel and a cathode effluent channel, etc. In some embodiments, a power supply 130 is in electrical communication with the one or more porous anodes and the one or more porous cathodes that facilitate an oxidation-reduction reaction at the porous anode and the porous cathode. In some embodiments, electrolyzer 102 produces one or more acidic product streams 122, e.g., from an anode effluent channel. In some embodiments, electrolyzer 102 produces one or more alkaline product streams 124, e.g., from a cathode effluent channel. In some embodiments, at least portions of acidic product streams 122 and alkaline product streams 124 are further processed by other components from system 100, as will be discussed below.

In some embodiments, one or more gas inlet streams 120 are in fluid communication with electrolyzer 102, e.g., a reactor chamber. As discussed above, in some embodiments, gas inlet stream 120 includes at least a portion of a gaseous stream evolved in and recycled to electrolyzer 102. In some embodiments, one or more aqueous salt solution inlet streams 118 are in fluid communication with electrolyzer 102, e.g., a feed channel.

In some embodiments, system 100 includes a feedstream 132 including aqueous salt solution. Feedstream 132 can come from any suitable source. In some embodiments, feedstream 132 includes brine, brackish water, seawater, reject brine, or combinations thereof. In some embodiments, feedstream 132 is fed directly to electrolyzer 102. In some embodiments, feedstream 132 is fed to a precipitation tank 134. In some embodiments, feedstream 132 is first filtered using one or more filters 136, e.g., to remove any solids such as sand, seaweed, macroorganisms, etc., or combinations thereof. In some embodiments, filter 136 includes a hydrocyclone, another separation device, or combinations thereof.

In some embodiments, at least a portion of alkaline product streams 124 are also fed to precipitation tank 134. The presence of a portion of alkaline product stream 124 maintains precipitation tank 134 at an elevated pH, e.g., about 11. At this elevated pH, upon providing feedstream 132 to the precipitation tank 134, minerals such as those including alkaline earth metals are precipitate out of solution. In an exemplary embodiment, filtered water fed to precipitation tank 134 having pH maintained at about 11 i.) induces precipitation of Mg²⁺, Ca²⁺, or combinations thereof from water, and ii.) sterilizes the water, thereby minimizing biofouling throughout the rest of the system. Without wishing to be bound by theory, precipitation occurs based on the following Equation 4:

Mg²⁺+2OH—→Mg(OH)₂₍ₛ₎Kₛₚ=10.8E-11M³ (4.)

In some embodiments, precipitated solids are removed from feedstream 132 as a metal-including product outlet stream 138. In some embodiments, metal-including product outlet stream 138 includes one or more metals, one or more metal compounds, one or more metal hydroxides, one or more metal oxides, one or more metal carbonates, or combinations thereof. In some embodiments, precipitated solids are phase separated from feedstream 132, e.g., using settling tanks, rotary drum filters or similar devices, or combinations thereof. In some embodiments, the remaining feedstream 132 is fed to electrolyzer 102 as at least a portion of aqueous salt solution inlet stream 118, e.g., to a feed channel therein.

In some embodiments, a carbon dioxide feedstream 140 is in communication with precipitation tank 134. In some embodiments, carbon dioxide feedstream 140 has a dilute concentration of CO₂, e.g., ambient air. In these embodiments, solids precipitated from feedstream 132 and removed via metal-including product outlet stream 138 include metal carbonates, and thus system 100 can be configured for use in the capture and/or concentration of CO₂. In some embodiments, the metal carbonates are further processed to release the captured CO₂. In some embodiments, metal-including product outlet stream 138 (including a concentration of metal carbonates) is contacted with at least a portion of acidic product stream 122 to reduce the pH of stream 138 and release concentrated CO₂.

In some embodiments, system 100 includes one or more mixing tanks 142. In some embodiments, a mixing tank 142 is in fluid communication with at least a portion of acidic product stream 122. In some embodiments, mixing tank 142 is also in fluid communication with metal-including product outlet stream 138, an alkaline mineral source 144A, a seawater source 144B, or combinations thereof. In some embodiments, at least a portion of acidic product stream 122 is neutralized by “accelerated weathering” in mixing tank 142. In some embodiments, at least a portion of acidic product stream 122 is neutralized by reaction with alkaline minerals, e.g., olivines such as Forsterite, other alkaline mineral, or combinations thereof. In some embodiments, the alkaline minerals, e.g., from alkaline mineral source 144A, are added to the bottom of mixing tank 142. In some embodiments, at least a portion of acidic product stream 122 is contacted with a seawater source 144B to release CO₂ therefrom. Without wishing to be bound by theory, CO₂ is initially present in seawater source 144B as bicarbonate HCO₃⁻. Addition of acidic product stream 122 to seawater source 144B helps drive the following reaction 5 and produce CO₂.

H⁺+HCO₃⁻→CO₂(g)+H₂O (5.)

In some embodiments, the production of CO₂ generally resembles direct ocean capture of CO₂.

In some embodiments, neutralization of acidic product stream 122 in mixing tank 142 generates product stream 146. In some embodiments, product stream 146 includes silica (SiO₂) or other solid mineral byproduct, concentrated CO₂, etc., or combinations thereof. In some embodiments, product stream 146 is separated, e.g., a rotary drum filter or other means, and the pH of the liquid stream is slightly above normal seawater pH, which is advantageous to help combat ocean acidification.

In some embodiments, system 100 includes one or more additional electrolyzers 102. In some embodiments, system 100 includes an electrolyzer 102A configured to generate one or more product streams 148 via electrolysis of at least a portion of alkaline product stream 124 according to reactions 6-8 below:

Oxidation:4OH⁻→O₂+2H₂O+4e⁺E°=+0.46Vvs.NHE at pH13 (6.)

Reduction:2H₂O+2e⁻→2OH⁻+H₂E°=−0.77Vvs.NHE at pH13 (7.)

Overall:H₂O→H₂+0.5O₂ΔE°=1.23V (8.)

In some embodiments, electrolyzer 102A includes the electrolyzer stack, phase separators, dryer, etc. In some embodiments, evolved oxygen is captured, vented to the atmosphere, recycled to system 100, or combinations thereof. In some embodiments, evolved hydrogen is captured, recycled to system 100, or combinations thereof. In some embodiments, electrolyzer 102A includes a deoxygenator to help produce higher purity hydrogen. Carrying out a water electrolysis reaction in alkaline media is very effective for avoiding the undesirable chlorine evolution reaction, in addition to being able to avoid the need for precious metal catalysts. In some embodiments, the flow rate through electrolyzer 102A is set to avoid any undesirable increases in salinity while minimizing “waste” of OH⁻ that will eventually be neutralized, as will be discussed in greater detail below.

In some embodiments, system includes an electrolyzer 102B configured to produce one or more product streams 150. In some embodiments, a product stream 150 is generated via chlor-alkali reactions 9-11:

Reduction:2H₂O+O₂+4e⁺→4OH⁻ (9.)

Oxidation:2Cl⁻→Cl₂+2e⁻ (10.)

Overall:2H₂O+4Cl⁻+O₂→4OH⁻+2Cl₂ (11.)

In these embodiments, the feed to electrolyzer 102B is demineralized and pH neutral, e.g., is a combination of at least a portion of acidic product stream 122 and remaining feedstream 132, i.e., a portion of aqueous salt solution inlet stream 118. In some embodiments, electrolyzer 102B includes an anode electrocatalyst used at the anode for selective evolution of Cl₂. Without wishing to be bound by theory, these embodiments are advantageous over traditional chlor-alkali process based on membranes at least because it removes the capital-intensive pre-treatment of brines to remove Mg, Ca, SO₄, and other impurities.

Referring again to FIG. 2, in some embodiments, system 100 includes one or more neutralization tanks 152. In some embodiments, neutralization tank 152 receives at least a portion of acidic product stream 122. In some embodiments, neutralization tank 152 receives at least a portion of alkaline product stream 124. In some embodiments, at least a portion of acidic product stream 122 and alkaline product stream 124 are combined to return the pH of the combined stream back to a value similar to its natural value. In some embodiments, the portions of acidic product stream 122 and alkaline product stream 124 combined in neutralization tanks 152 are excess streams, e.g., portions of the streams emitted from precipitation tank 134, mixing tank 142, etc. In some embodiments, neutralization tank 152 receives an excess alkaline stream 154 from electrolyzer 102A. In some embodiments, neutralization tank 152 receives an excess neutral stream 156 from electrolyzer 102B. In some embodiments, neutralization tank 152 receives excess acidic stream 158 from mixing tank 142. In some embodiments, neutralization tank 152 produces a neutral product stream 160. In some embodiments, at least one neutral stream produced in system 100, e.g., neutral stream 156, neutral product stream 160, etc., are recycled back to electrolyzer 102, e.g., to a feed channel 112.

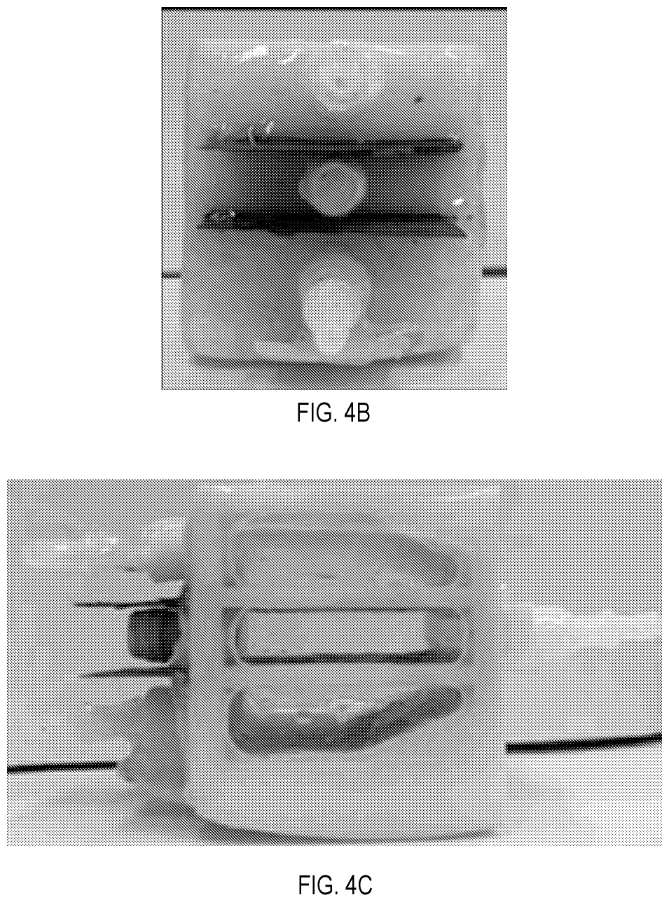

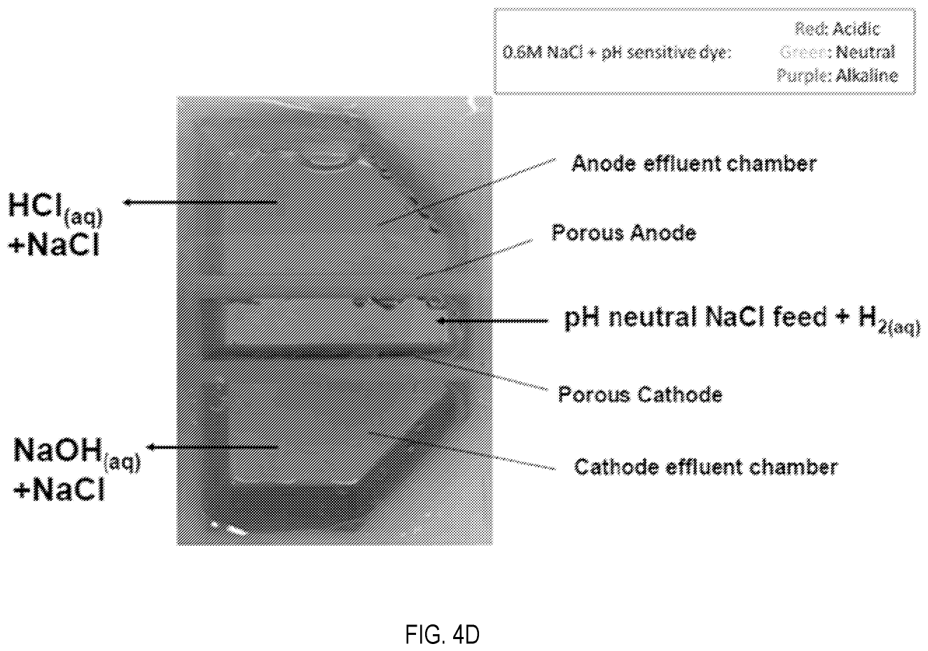

Referring now to FIGS. 4A-4D, images of electrolyzers consistent with the embodiments described above are shown. Referring specifically to FIG. 4A, the electrolyzer includes two electrodes of 100 ppi carbon foam with electrodeposited Pt electrocatalysts. The electrodes had an area of about 1.8 cm². In this embodiment, the cell body included ABS. The electrolyzer in FIG. 4A is shown during steady state electrolysis of Mg-free seawater in the presence of universal pH indicator dye, which is green at neutral pH but turns red in acidic environments and purple in alkaline environments. The inlet flow rate was 10 mL/min and the cell voltage was 1 V. FIG. 4B portrays a back view of an electrolyzer with additional H₂ gas inlet port. FIG. 4C portrays a side view of an electrolyzer with additional H₂ gas inlet port. FIG. 4D portrays another side view of an electrolyzer during operation with pH sensitive colorimetric dye.

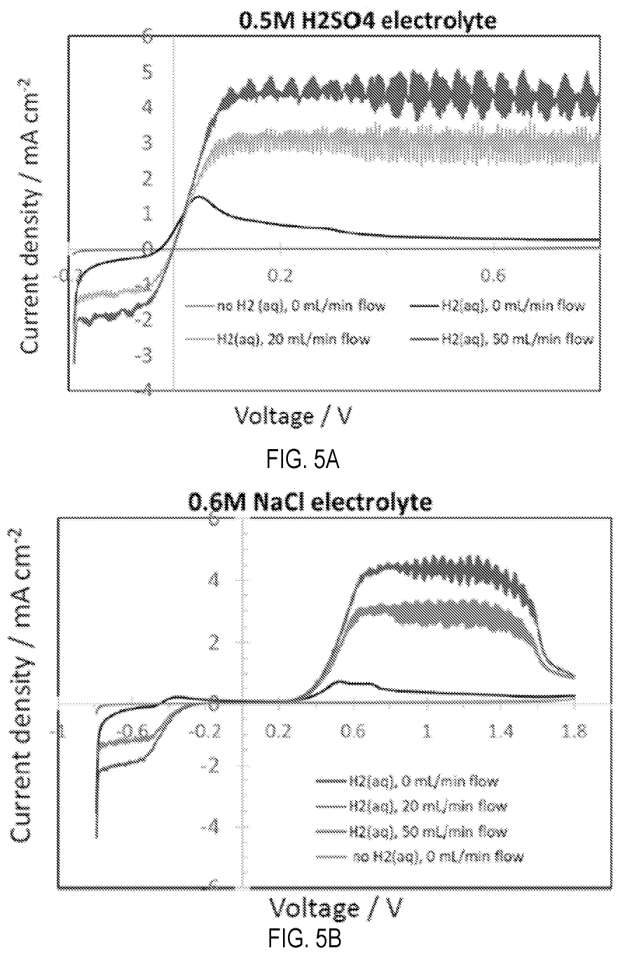

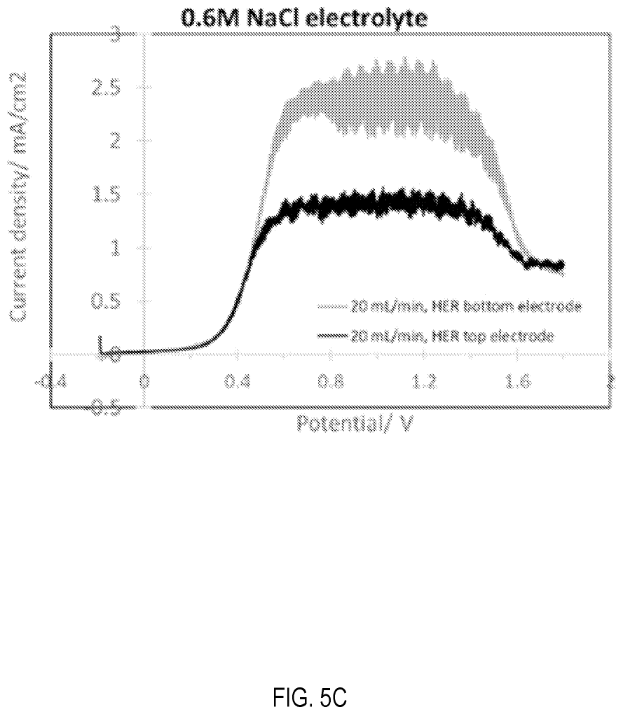

Referring now to FIG. 5A, current-voltage curves are shown for electrolyzers using acidic feedstream (0.5 M H₂SO₄), illustrating the influence of feedstream flow rate (0, 20, or 50 mL/min) as well as the presence of H₂(aq) in the feedstream. FIG. 5B shows current-voltage curves for electrolyzers using aqueous 0.6M NaCl as the inlet stream, illustrating the influence of feedstream flow rate (0, 20, or 50 mL/min) as well as the presence of H₂(aq) in the feedstream. FIG. 5C shows current-voltage curves for electrolyzers using aqueous 0.6M NaCl and H₂(aq) as the inlet stream at a feedstream flow rate 20 mL/min, illustrating the influence of electrode polarity on the limiting current density.

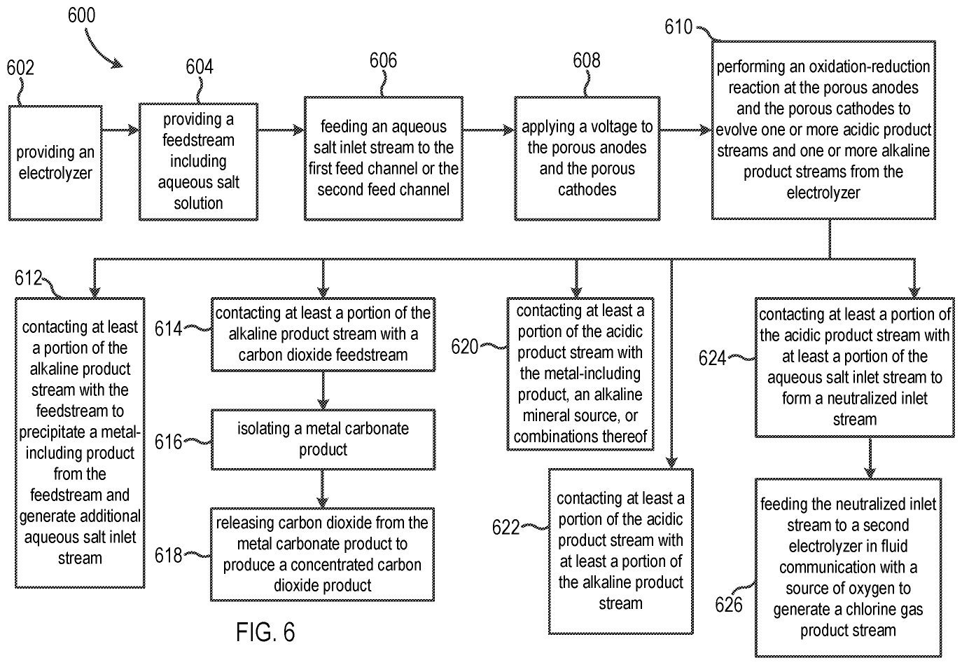

Referring now to FIG. 6, some embodiments of the present disclosure are directed to a method 600 for producing acidic and alkaline products from aqueous salt solutions. At 602, one or more electrolyzers are provided. In some embodiments, the electrolyzers are consistent with electrolyzer 102 discussed above. In some embodiments, at least one of the electrolyzers includes multiple reaction chambers connected in a stacked configuration as discussed above to generate more and more acidic/basic product streams until the desired acidity/basicity of the product streams is achieved, at which time the product streams can be removed from the electrolyzer.

At 604, a feedstream including aqueous salt solution is provided. In some embodiments, the feedstream includes brine, brackish water, seawater, reject brine, or combinations thereof. At 606, an aqueous salt inlet stream is fed to the electrolyzer, e.g., to a first feed channel, second feed channel, etc. In some embodiments, the aqueous salt inlet stream includes the feedstream, a filtered component of the feedstream, a demineralized component of the feedstream, a feedstream having increased basicity, or combinations thereof. At 608, a voltage is applied to porous anode and porous cathode pairs in the electrolyzer. At 610, an oxidation-reduction reaction is performed at the porous anodes and the porous cathodes to evolve one or more acidic product streams and one or more alkaline product streams from the electrolyzer as discussed above.

At 612, at least a portion of the alkaline product stream is contacted with the feedstream. In some embodiments, contacting 612 precipitates a metal-including product from the feedstream. In some embodiments, as discussed above, feedstream contacted 612 with at least a portion of the alkaline product stream is fed to the electrolyzer as the aqueous salt inlet stream or as additional aqueous salt inlet stream.

In some embodiments, at 614, at least a portion of the alkaline product stream is contacted with a carbon dioxide feedstream. In some embodiments, at 616, a metal carbonate product is then isolated. In some embodiments, at 618, carbon dioxide is released from the metal carbonate product to produce a concentrated carbon dioxide product.

In some embodiments, at 620, at least a portion of the acidic product stream is contacted with the metal-including product, an alkaline mineral source, or combinations thereof. In some embodiments, at 622, at least a portion of the acidic product stream is contacted with at least a portion of the alkaline product stream.

In some embodiments, at 624, at least a portion of the acidic product stream is contacted with at least a portion of the aqueous salt inlet stream to form a neutralized inlet stream. In some embodiments, at 626, the neutralized inlet stream is fed to a second electrolyzer in fluid communication with a source of oxygen to generate a chlorine gas product stream, as discussed above.

Methods and systems of the present disclosure advantageously produce acidic and alkaline effluent streams from salt water (brine) using safe and simple device architectures that does not necessitate the use of membranes. The embodiments of the membraneless electrolyzers discussed above can generate an alkaline salt water stream having an alkalinity sufficient to drive metal ion precipitation, e.g., Mg²⁺, and can be increased further through optimization of the electrode and device designs. The systems utilize significantly lower voltage compared to generating acid and base through the overall water splitting reaction. The systems are also safer. For example, the systems can generate acid and base from seawater while completely avoiding the generation of chlorine gas or other reactive chlorine species, a major challenge for conventional approaches to making acid and base from seawater. The primary oxidant and reductant species are the same, e.g., H₂ or O₂, eliminating co-production of an oxidant species, e.g., O₂ or Cl₂, and reductant species, e.g., H₂, that would form an explosive mixture.

Electrodialysis devices that rely on alternating cation exchange membranes and anion exchange membranes can be costly, and the ion exchange membranes are susceptible to fouling or degradation, especially in the presence of seawater impurities. In general, the lack of stable AEMs that can operate in seawater is a major impediment to direct seawater electrolysis technologies. Thus, an electrolyzer that completely avoids the needs for membranes has an advantage for operation in seawater. Recirculating raw seawater to first sterilize it in the alkaline precipitation tank before reaching the membraneless electrolyzer can reduce fouling or degradation of electrolyzer electrodes of an electrolyzer. Removal of Mg′ ions before the seawater reaches the electrolyzer has the added benefit of avoiding Mg(OH)₂ deposits from forming on the electrolyzer cathode, another common concern in seawater electrolysis.

Accordingly, these systems represent a durable and cost-effective manner for producing acid and base for a variety of applications, including but not limited to CO₂ capture and/or concentration, seawater electrolysis, accelerated weathering, harvesting alkali earth metals from seawater, disinfecting water, creating anti-scaling solutions, mining/metallurgy applications, etc. The benefits of the systems and methods according to the present disclosure would be particularly advantageous to chemical companies, companies/investors interested in carbon capture and sequestration, electrolyzer companies, the water treatment industry, governments/agencies concerned with ocean acidification, etc.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for producing acidic and alkaline products from aqueous salt solutions, comprising:
an electrolyzer including:
at least one reactor chamber including a feed channel, an anode effluent channel, and a cathode effluent channel;
one or more porous anodes positioned between the feed channel and the anode effluent channel;
one or more porous cathodes positioned between the feed channel and a cathode effluent channel;
one or more aqueous salt solution inlet streams in fluid communication with the feed channel;
one or more gas inlet streams in fluid communication with the at least one reactor chamber;
one or more acidic product streams in fluid communication with the anode effluent channel, and
one or more alkaline product streams in fluid communication with the cathode effluent channel;
wherein a first porous anode and a first porous cathode are positioned in a stacked configuration with the feed channel disposed therebetween.

2. The system according to claim 1, wherein the aqueous salt solution inlet stream includes brine, brackish water, seawater, reject brine, or combinations thereof.

3. The system according to claim 1, wherein the gas inlet stream is dissolved gas in the aqueous salt solution inlet stream.

4. The system according to claim 1, wherein the gas inlet stream includes hydrogen, oxygen, chlorine, or combinations thereof.

5. The system according to claim 1, wherein a first gaseous stream is evolved at the first porous cathode.

6. The system according to claim 5, wherein at least a portion of the first gaseous stream is recycled to the first anode.

7. The system according to claim 1, wherein a first gaseous stream is evolved at the first porous anode, and at least a portion of the first gaseous stream is recycled to the reactor chamber.

8. The system according to claim 1, wherein the electrolyzer includes:
a first reactor chamber including a first feed channel, a first anode effluent channel, and a first cathode effluent channel; and
at least a second reactor chamber including a second feed channel, a second anode effluent channel, and a second cathode effluent channel,
wherein a first acidic product stream from the first anode effluent channel is in fluid communication with the second feed channel, a first alkaline product stream is in fluid communication with the first cathode effluent channel, a second acidic product stream is in fluid communication with the second anode effluent channel, and a second alkaline product stream from the second cathode effluent channel is in fluid communication with the first feed channel.

9. The system according to claim 1, wherein the one or more acidic product streams are in communication with a second electrolyzer, a mixing tank including alkaline minerals, a neutralization unit including at least a portion of an alkaline product stream, or combinations thereof.

10. The system according to claim 1, wherein the one or more alkaline product streams are in communication with a carbon dioxide feed stream, a water electrolyzer, a feedstream of aqueous salt solution, a neutralization unit include at least a portion of an acidic product stream, or combinations thereof.

11. A system for producing acidic and alkaline products from aqueous salt solutions, comprising:
an electrolyzer including,
a reactor chamber including a feed channel, an anode effluent channel, and a cathode effluent channel;
one or more porous anodes positioned between the feed channel and the anode effluent channel; and
one or more porous cathodes positioned between the feed channel and a cathode effluent channel,
wherein a first porous anode and a first porous cathode are positioned in a stacked configuration with the feed channel disposed therebetween,
one or more gas inlet streams in fluid communication with the at least one reactor chamber;
one or more acidic product streams in fluid communication with the anode effluent channel;
one or more alkaline product streams in fluid communication with the cathode effluent channel;
a feedstream including aqueous salt solution;
a precipitation tank in fluid communication with the feedstream and at least a portion of the one or more alkaline product streams, the precipitation tank producing an aqueous salt solution inlet stream in fluid communication with the feed channel and a metal-including product outlet stream;
one or more neutralization tanks in fluid communication with at least a portion of the one or more alkaline product streams and at least a portion of the one or more acidic product streams; and
a power supply in electrical communication with the one or more porous anodes and the one or more porous cathodes.

12. The system according to claim 11, wherein the feedstream includes brine, brackish water, seawater, reject brine, or combinations thereof.

13. The system according to claim 11, further comprising a carbon dioxide feedstream in communication with the precipitation tank.

14. The system according to claim 11, further comprising a second electrolyzer in fluid communication with at least a portion of the one or more alkaline product streams, the second electrolyzer producing a hydrogen gas product, an oxygen product, or combinations thereof.

15. The system according to claim 11, further comprising a mixing tank in fluid communication with at least a portion of the one or more acidic product streams and the metal-including product outlet stream, an alkaline mineral source, or combinations thereof.

16. A method for producing acidic and alkaline products from aqueous salt solutions, comprising:
providing an electrolyzer including:
a first reactor chamber including:
a first feed channel;
a first anode effluent channel;
a first cathode effluent channel;
a first porous anode positioned between the first feed channel and the first anode effluent channel; and
a first porous cathode positioned between the first feed channel and the first cathode effluent channel,
wherein a first porous anode and a first porous cathode are positioned in a stacked configuration with the first feed channel disposed therebetween; and
a second reactor chamber including:
a second feed channel;
a second anode effluent channel;
a second cathode effluent channel;
a second porous anode positioned between the second feed channel and the second anode effluent channel; and
a second porous cathode positioned between the second feed channel and the second cathode effluent channel,
wherein the second porous anode and the second porous cathode are positioned in a stacked configuration with the second feed channel disposed therebetween,
one or more aqueous salt solution inlet streams in fluid communication with the first feed channel, the second feed channel, or combinations thereof; and
one or more gas inlet streams in fluid communication with the first reactor chamber, the second reactor chamber, or combinations thereof,
wherein an acidic stream from the first anode effluent channel is fed to the second feed channel and an alkaline stream from the second cathode effluent channel is fed to the first feed channel;
providing a feedstream including aqueous salt solution;
feeding an aqueous salt inlet stream to the first feed channel or the second feed channel;
applying a voltage to the porous anodes and the porous cathodes;
performing an oxidation-reduction reaction at the porous anodes and the porous cathodes to evolve one or more acidic product streams and one or more alkaline product streams from the electrolyzer; and
contacting at least a portion of the alkaline product stream with the feedstream to precipitate a metal-including product from the feedstream and generate additional aqueous salt inlet stream,
wherein the feedstream includes brine, brackish water, seawater, reject brine, or combinations thereof.

17. The method according to claim 16, further comprising:
contacting at least a portion of the alkaline product stream with a carbon dioxide feedstream,
isolating a metal carbonate product, and
releasing carbon dioxide from the metal carbonate product to produce a concentrated carbon dioxide product.

18. The method according to claim 16, further comprising contacting at least a portion of the acidic product stream with the metal-including product, an alkaline mineral source, or combinations thereof.

19. The method according to claim 16, further comprising contacting at least a portion of the acidic product stream with at least a portion of the alkaline product stream.

20. The method according to claim 16, further comprising:
contacting at least a portion of the acidic product stream with at least a portion of the aqueous salt inlet stream to form a neutralized inlet stream, and
feeding the neutralized inlet stream to a second electrolyzer in fluid communication with a source of oxygen to generate a chlorine gas product stream.
